(19) United States
(12) Patent Application Publication
(10) Pub. No.: US 2026/0270671 A1
(43) Pub. Date: Sep. 10, 2026

(54) Managing Bluetooth Low Energy (BLE) Bandwidth Usage Across Different Devices

(71) Applicant: Google LLC, Mountain View, CA (US)

(72) Inventor: Sunil Kumar, Cupertino, CA (US)

(21) Appl. No.: 19/473,119

(22) PCT Filed: Apr. 5, 2024
(86) PCT No.: PCT/US2024/023261

§ 371 Date: Oct. 6, 2025

Related U.S. Application Data
(60) Provisional application No. 63/494,903, filed on Apr. 7, 2023.

(51) Int. Cl. H04W 4/80; H04W 76/10

(52) U.S. Cl. CPC H04W 4/80; H04W 76/10

(57) ABSTRACT

Various arrangements for managing Bluetooth Low Energy (BLE) bandwidth usage across different devices are described herein. The techniques described include prioritizing HID traffic over Close Isochronous Event (CIE) traffic. Generally, a CIE is used by a computing device (e.g., a call gateway) to indicate that audio traffic for the event has been successfully delivered and received by another computing device. Using the techniques described herein, the user experience can be improved by helping to ensure that not only the user experience of the audio traffic is good, but also that the user experience with other HIDs are good (e.g., improved HID latency).

### CROSS REFERENCES TO RELATED APPLICATIONS

This Application claims priority to U.S. Provisional Patent Application No. 63/494,903, entitled “Managing Bluetooth Low Energy (BLE) Bandwidth Usage Across Different Devices”, filed on Apr. 7, 2023, the entire disclosure of which is hereby incorporated by reference for all purposes.

### BACKGROUND

Bluetooth Low Energy (BLE) communications can be used by a wide variety of devices. For example, BLE can be used to support telephony (cellular) and Voice-Over-IP (VOIP) calls, while also being used by Human Interface Devices (HIDs), such as keyboards and mice. For instance, when BLE is used for a Super Wide Band (SWB) voice call (audio bandwidth>=14 KHz) or some other audio use case, the available Bluetooth (BT) bandwidth for other devices (e.g., HIDs) is reduced. In some cases, this may degrade the performance of the other devices.

### SUMMARY

Various embodiments for managing Bluetooth Low Energy (BLE) bandwidth usage across different devices are described herein. The techniques described include prioritizing HID traffic over audio link traffic in some cases. For instance, according to some examples, HID traffic may be prioritized over sending a Close Isochronous Event (CIE) associated with audio link traffic. Generally, a CIE is used by a computing device (e.g., a call gateway) to indicate that audio/voice traffic for the event has been successfully delivered and received by another computing device, such as a wireless earbud. In some cases, both an uplink CIE and a downlink CIE can be transmitted that indicates that uplink traffic and downlink traffic has been successfully delivered and received, and therefore, there is no further need of the retransmissions during the interval. The CIE is used by the receiving device to indicate that the other device will not make any further transmissions within the interval. In other examples, HID traffic can be prioritized over other types of transmissions (e.g., confirmation messages, handshakes, . . . ) . Generally, in the case when a receiving device does not receive a CIE, the receiving device continues to listen for data during the interval.

Prior to techniques described herein, the audio link traffic would be prioritized over the HID traffic such that when there is any conflict, the audio link traffic is sent and the HID traffic is not sent. Using the techniques described herein, the user experience can be improved by helping to ensure that not only the user experience of the audio/voice traffic is good, but also that the user experience with other HIDs are good (e.g., improved HID latency). In addition to improving the experience dealing with HIDs, Wi-Fi throughput may also be improved.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for managing usage of Bluetooth Low Energy (BLE) bandwidth. The method also includes establishing a connected isochronous stream (CIS) connection to communicate audio link traffic between a first computing device and a second computing device. The method also includes determining a conflict between the audio link traffic and human interface device (HID) traffic. The method also includes prioritizing the HID traffic over the audio link traffic based at least in part on the conflict. Other embodiments of this aspect include corresponding computer systems, apparatus, and computer programs recorded on one or more computer storage devices, each configured to perform the actions of the methods.

Implementations may include one or more of the following features. The method where determining the conflict may include determining that close isochronous event (CIE) traffic conflicts with the HID traffic. Prioritizing the HID traffic over the audio link traffic may include preventing the CIE from one or more of scheduled or transmitted. The method may include determining that the CIS connection is used for a super wide band call that has an audio bandwidth greater than about 14 KHz. The method may include transmitting CIE traffic when no conflict exists. The HID traffic includes data associated with an input device. The second computing device is an earbud. Implementations of the described techniques may include hardware, a method or process, or computer software on a computer-accessible medium.

One general aspect includes a wireless system that uses a Bluetooth Low Energy (BLE) protocol. The wireless system also includes a first computing device, may include a first wireless interface, and a first processing system, where the first computing device is configured to establish a connected isochronous stream (CIS) connection to communicate audio link traffic between the first computing device and a second computing device. The system also includes functionality to determine a conflict between the audio link traffic and human interface device (HID) traffic; and prioritize the HID traffic over the audio link traffic based at least in part on the conflict. Other embodiments of this aspect include corresponding computer systems, apparatus, and computer programs recorded on one or more computer storage devices, each configured to perform the actions of the methods.

Implementations may include one or more of the following features. The wireless system where determining the conflict may include determining that close isochronous event (CIE) traffic conflicts with the HID traffic. Prioritizing the HID traffic over the audio link traffic may include preventing the CIE from one or more of scheduled or transmitted. The CIS connection is used for a super wide band call that has an audio bandwidth greater than about 14 KHz. The first computing device is further configured to transmit CIE traffic when no conflict exists. The HID traffic includes data associated with an input device. The second computing device is an earbud.

Implementations of the described techniques may include hardware, a method or process, or computer software on a computer-accessible medium.

One general aspect includes a non-transitory computer-readable medium containing computer executable instructions that when executed perform establishing a connected isochronous stream (CIS) connection to communicate audio link traffic between a first computing device and a second computing device. The instructions also include determining a conflict between the audio link traffic and human interface device (HID) traffic. The instructions also include prioritizing the HID traffic over the audio link traffic based at least in part on the conflict. Other embodiments of this aspect include corresponding computer systems, apparatus, and computer programs recorded on one or more computer storage devices, each configured to perform the actions of the methods.

Implementations may include one or more of the following features. The non-transitory computer-readable medium where determining the conflict may include determining that close isochronous event (CIE) traffic conflicts with the HID traffic. Prioritizing the HID traffic over the audio link traffic may include preventing the CIE from one or more of scheduled or transmitted.

The CIS connection is used for a super wide band call that has an audio bandwidth greater than about 14 KHz. The computer executable instructions that, when executed by a processor, further cause the processor to transmit CIE traffic when no conflict exists. The HID traffic includes data associated with an input device and the second computing device is an earbud. Implementations of the described techniques may include hardware, a method or process, or computer software on a computer-accessible medium.

### BRIEF DESCRIPTION OF THE DRAWINGS

FIG. 1 illustrates a system that manages Bluetooth Low Energy (BLE) bandwidth usage across different devices.

FIG. 2A illustrates frames thirteen to twenty-four showing the use of bandwidth between audio link traffic and HID traffic.

FIG. 2B illustrates frames one to twelve showing the use of bandwidth between audio link traffic and HID traffic.

FIG. 2C illustrates frames twenty-five to thirty-six showing the use of bandwidth between audio link traffic and HID traffic.

FIG. 2D illustrates frames thirty-seven to forty-eight showing the use of bandwidth between audio link traffic and HID traffic.

FIG. 2E illustrates frames forty-nine to sixty showing the use of bandwidth between audio link traffic and HID traffic.

FIG. 2F illustrates frames sixty-one to seventy-two showing the use of bandwidth between audio link traffic and HID traffic.

FIG. 2G illustrates frames seventy-three to eighty-four showing the use of bandwidth between audio link traffic and HID traffic.

FIG. 3 illustrates prioritizing HID traffic over CIE traffic.

FIG. 4 illustrates a process for managing BLE bandwidth usage across different devices.

### DETAILED DESCRIPTION

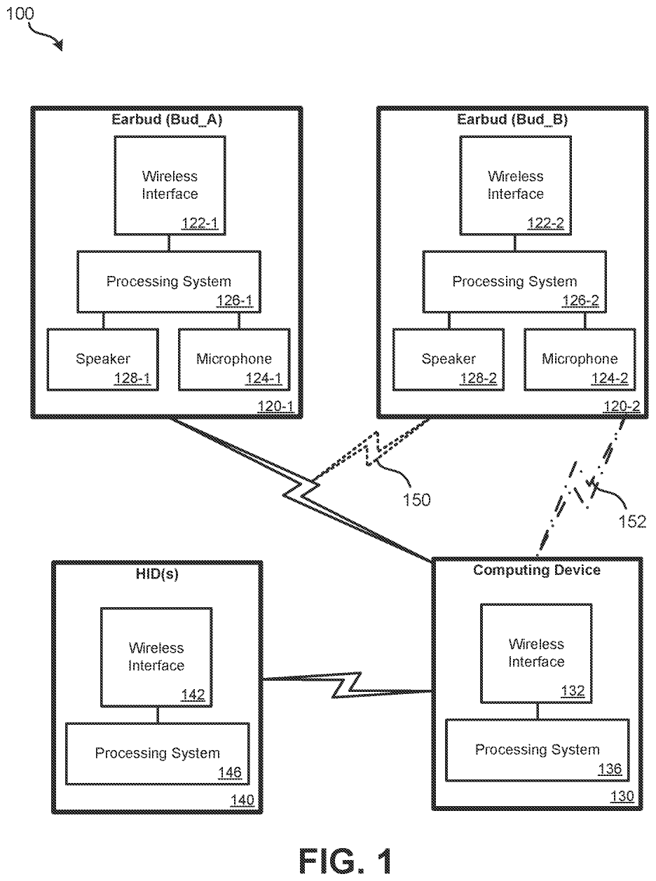

FIG. 1 illustrates a system 100 that manages Bluetooth Low Energy (BLE) bandwidth usage across different devices. System 100 shows data that is transmitted between earbuds 120, computing device 130, and HID(s) 140. Downstream audio is transmitted from computing device 130 to earbuds 120 and upstream audio (e.g., voice captured via microphone) is transmitted from one or more of the earbuds 120 to computing device 130. As illustrated, system 100 includes: earbud 120-1 (e.g., a right or left earbud of a pair of true wireless earbuds); earbud 120-2 (e.g., a true wireless earbud for the opposite ear from earbud 120-1); computing device 130, and one or more HID(s) (e.g., a mouse, a keyboard, a touchscreen, game controller, . . . ).

The computing device 130 and the earbuds 120 are configured to support telephony (cellular) and Voice-Over-IP (VOIP) call use cases using Bluetooth Low Energy (BLE) technology. As illustrated in FIG. 1, the computing device 130 is configured to perform a Call Gateway (CG) role and the earbuds 120 are configured to perform the Call Terminal (CT) roles. In some examples, BLE may be used to support Super Wide Band (SWB) voice call (audio bandwidth>=14 KHz) calls. In other examples, BLE may support other types of audio traffic (e.g., music, games, . . . ) . In some configurations, a different communication protocol can be used for communication between earbuds 120, computing device 130, and HID 140.

Earbuds 120 can be true wireless earbuds, which refer to a pair of earbuds that do not have any physical connection, such as a wire or band, connecting the two earbuds or with an audio source. True wireless earbuds can allow a user to use both earbuds 120 or use a single earbud (either earbud 120-1 or earbud 120-2) at a given time.

Some components of earbuds 120 are illustrated in FIG. 1. Specifically, earbuds 120 can include: wireless interfaces 122; microphones 124; processing systems 126; and speakers 128. All components of earbuds 120 can be housed by housings of the respective earbud, which can be made from a rigid or semi-rigid material. Earbuds 120 can be shaped to be at least partially inserted into a user's ear so that it will stay in place during normal body movements.

Wireless interface 122 can be a short-range wireless interface that allows for a device-to-device exchange of data. For example, short-range refers to a distance of up to 1, 10, 15, or 20 meters. Wireless interface 122 can be a Bluetooth interface that allows for data to be exchanged according to a communication protocol from the Bluetooth family of communication protocols, such as Bluetooth basic rate or extended data rate (BR/EDR, which can also be referred to as “Bluetooth Classic”), BLE, and/or Bluetooth LE audio. Wireless interface 122 can communicate using the 2.4 GHz band, which for Bluetooth spans from 2.4 GHz to 2.4835 GHz. This frequency band can be divided up into a number of channels, such as 80 channels for Bluetooth BDR/EDR, each 1 MHz wide, or 40 channels for Bluetooth LE or LE Audio, which are each 2 MHz wide.

Bluetooth communications can involve frequent channel changes within the 2.4 GHz band, such as up to 1600 channel changes per second.

Wireless interfaces 122 can be understood as Bluetooth wireless interfaces in that each of wireless interfaces 122 can communicate with other Bluetooth interfaces (e.g., wireless interface 132) that conform to the Bluetooth standard. For example, in FIG. 1, audio source 130 has a Bluetooth interface, referred to as wireless interface 132. Wireless interfaces 122 can exchange data using Bluetooth LE with wireless interface 132. For example, wireless interface 132 may be used to transmit downstream audio packets to wireless interfaces 122 while upstream audio packets constructed using audio captured using one or more of microphones 124 are transmitted by wireless interfaces 122 to wireless interface 132.

In earbud 120-1, processing system 126-1 can be in communication with wireless interface 122-1; speaker 128-1; and microphone 124-1. In earbud 120-2, processing system 126-2 can be in communication with wireless interface 122-2; speaker 128-2; and microphone 124-2. Processing systems 126 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as flash memory or other forms of memory.

Speakers 128 are used for outputting audio to a user. Processing system 126 can control the volume of audio received via wireless interfaces 122. Microphones 124 are present in each of earbuds 120. Microphones 124 can be used to capture audio in the vicinity of earbuds 120, such as speech of a user wearing at least one of earbuds 120 and transmit the captured audio as upstream audio packets via Bluetooth (e.g., Bluetooth LE Audio) to computing device 130. Microphones 124 can also be used to capture audio to perform noise cancellation.

A single earbud, or two or more earbuds, may capture and stream upstream audio to computing device 130. Earbuds 120 may decide among themselves which earbud is to transmit upstream audio. For instance, the decision as to which earbud is to transmit upstream audio may be based on battery charge in each earbud, signal strength between each earbud and computing device 130, and/or an amount of noise detected by each earbud on captured audio. In some embodiments, the audio captured by each of microphones 124 is combined together to create an upstream audio stream that is transmitted to computing device 130.

An earbud manufacturer is not in control of the fundamental experience. Earbud manufacturers rely on the source's selection of microphone channel rather than the earbud's (and thus earbud manufacturer's) selection. Some phone manufacturers may decide to combine the microphone audio from both earbuds; others may choose to use only the left; yet others may choose the opposite; and others may choose to switch periodically based upon some algorithm that the earbud manufacturer had no way to determine.

A particular earbud of earbuds 120 may be designated as a “primary” earbud (PE) and the other earbud is designated as a second earbud (SE). In some examples, both the PE and the SE establish a control link and audio link with the computing device 130. In other examples, the PE, such as earbud 120-1 establishes a control link and an audio link with the computing device 130 while the SE, such as earbud 120-2, passively sniffs the and the control link (as illustrated by the dashed line) between the PE and the computing device 130.

In a first arrangement, a left (“L”) earbud and a right (“R”) earbud decide between themselves which one will send back microphone data to the phone. In some examples, the earbud 120 sending back microphone data using the audio link (e.g., a CIS connection) is the PE, and the other earbud is the SE. In both arrangements, one earbud can optionally sniff the microphone data sent by the other earbud. Sniffing is defined as capturing the data wirelessly transmitted that is intended for a device other than the one doing the sniffing. Combining the microphone data sent by another earbud with a given earbud's microphone can be useful for a multitude of purposes, amongst which are beamforming of sound capture, wind/ambient noise reduction, increasing SNR of sound capture, finding direction of an auditory stimulus around the user, etc. The arrangements detailed herein can also be applied to loudspeakers.

Computing device 130 includes wireless interface 132 and processing system 136. Examples of computing device 130 can include: a smartphone; a desktop, laptop, or tablet computer; a gaming device; a smart television; a digital music player device; a smartwatch; smart glasses; an augmented reality or a virtual reality headset; or any other device from which a user may desire to stream audio to earbuds 120 and, possibly, transmit upstream audio from earbuds 120 to computing device 130. Computing device 130 includes wireless interface 132, which can communicate with earbuds 120, and other devices, such as HID device 140, using device-to-device communication protocols, such as a Bluetooth communication protocol (e.g., Bluetooth Classic, Bluetooth LE, or Bluetooth LE Audio). Therefore, computing device 130 can transmit a downstream audio stream to one or more of earbuds 120 via wireless interface 132, receive an upstream audio stream from one or more of earbuds 120, and also communicate with one or more HID devices.

Processing system 136 may include one or more special-purpose or general-purpose processors. Such special-purpose processors may include processors that are specifically designed to perform the functions of the components detailed herein, such as detailed in relation to processing systems 126.

A particular earbud of earbuds 120 may be designated as a “primary” earbud (PE) and the other earbud is designated as a second earbud (SE). In some examples, both the PE and the SE establish a control and audio link with the computing device 130. In other examples, the PE has a control and an audio link with the computing device 130 while the SE passively sniffs the links between the PE and the computing device 130.

As briefly discussed above, techniques for managing Bluetooth Low Energy (BLE) bandwidth usage across different devices are described herein. The techniques described include, in some cases, prioritizing one type of audio link traffic over HID traffic. For instance, according to some examples, HID traffic may be prioritized over sending a CIE. As briefly discussed above, the purpose of a CIE is to indicate that audio traffic for the event has been successfully delivered and received by another computing device. In some cases, both an uplink CIE and a downlink CIE can be transmitted within an interval that indicates that uplink audio traffic and the downlink audio traffic has been successfully delivered and received, and therefore, there is no further need of the retransmissions during the interval.

The CIE is also used by the receiving device to indicate that the other device will not be any further transmissions within the interval. In other examples, HID traffic can be prioritized over other types of transmissions (e.g., confirmation messages, handshakes, . . . ). Generally, in the case when a receiving device does not receive a CIE close event, the receiving device continues to listen for data during the interval.

Prior to techniques described herein, the audio link traffic would be prioritized over the HID traffic such that when there is a conflict, the audio link traffic is sent but the HID traffic is not sent. Using the techniques described herein, the user experience can be improved by helping to ensure that not only the user experience of the audio traffic is good, but also that interaction with HIDs is good.

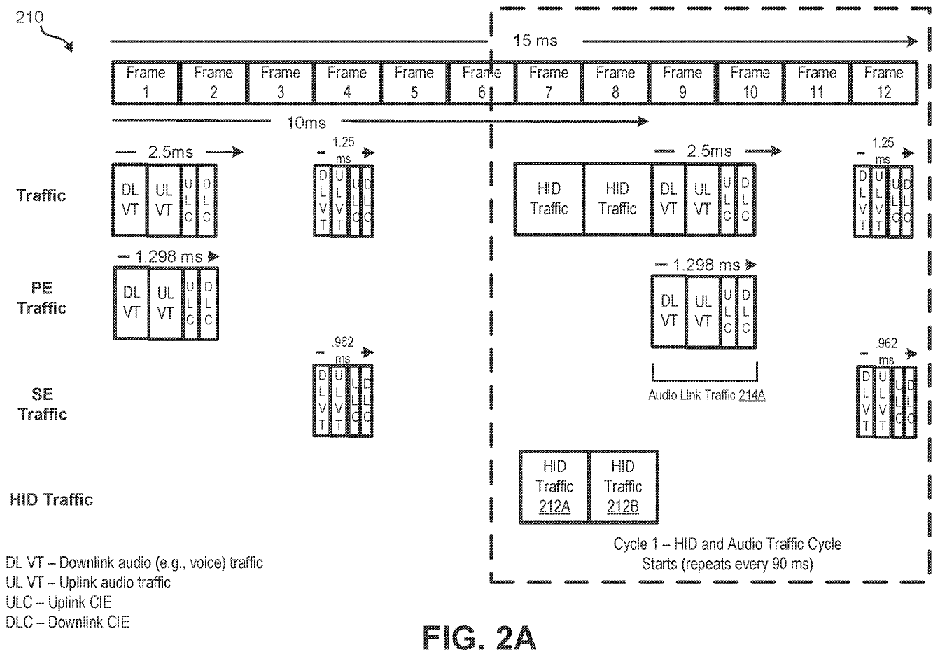

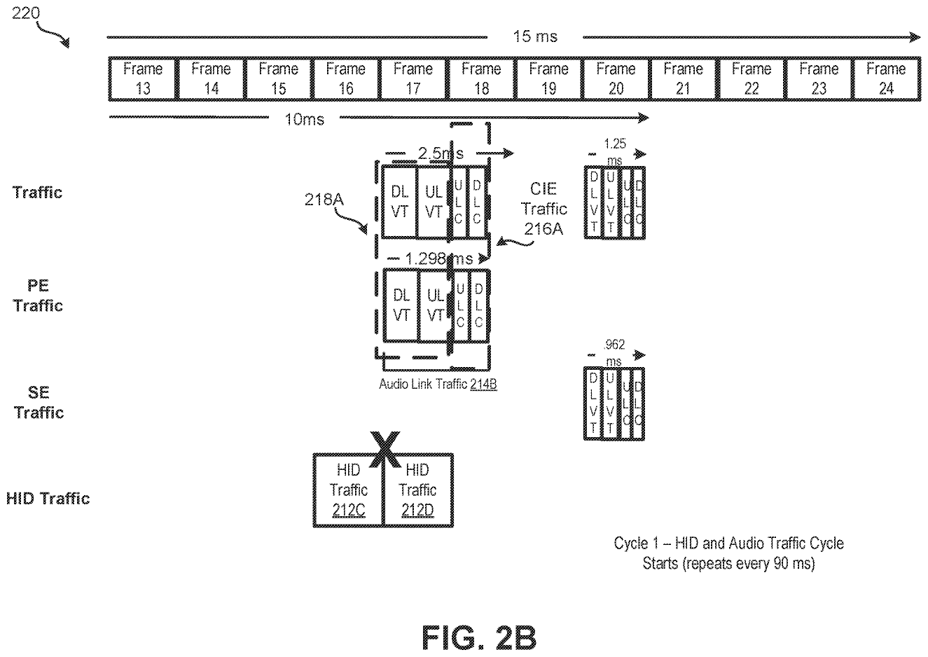

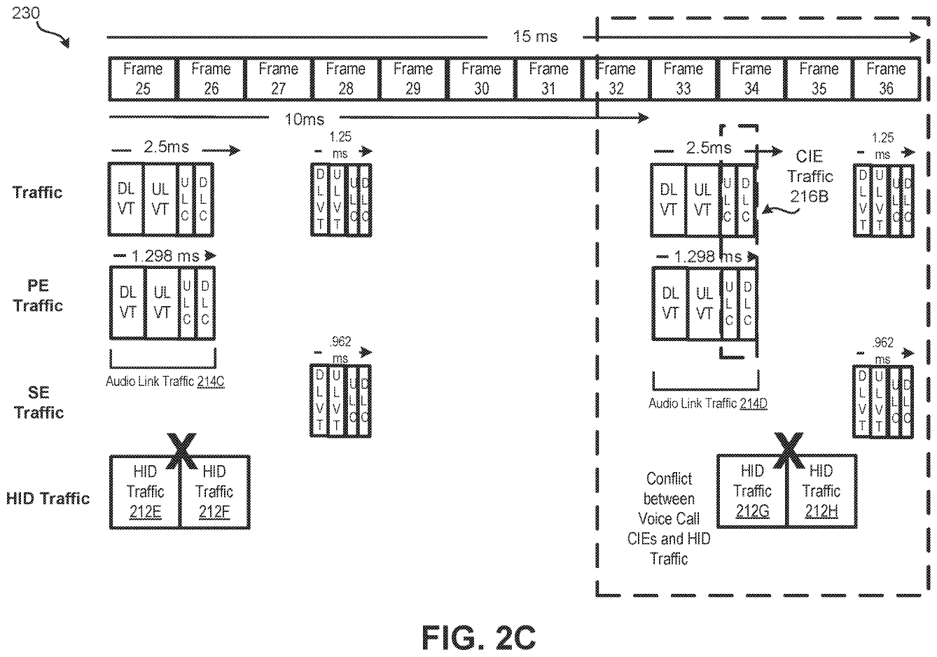

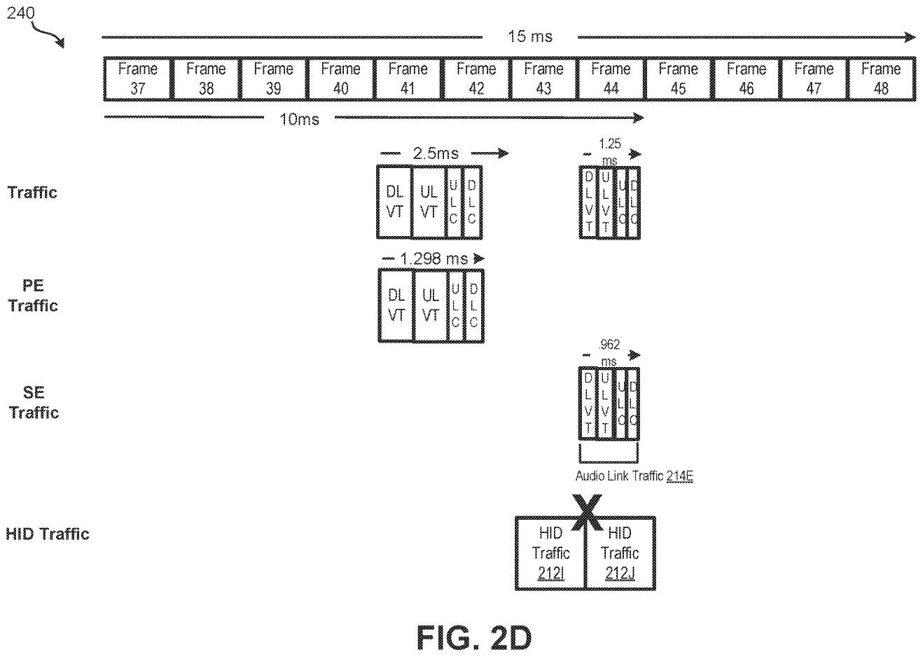

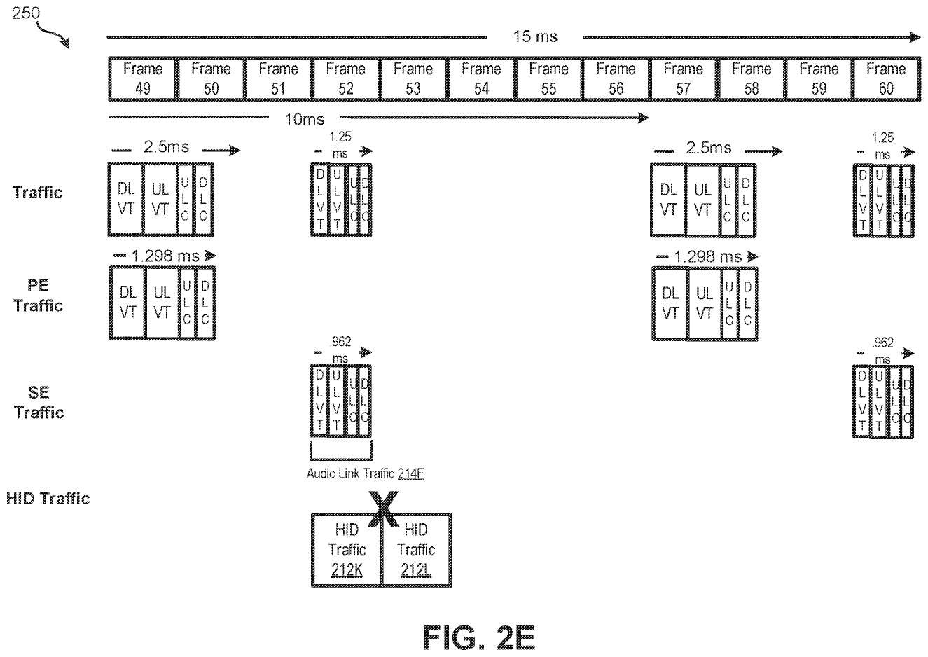

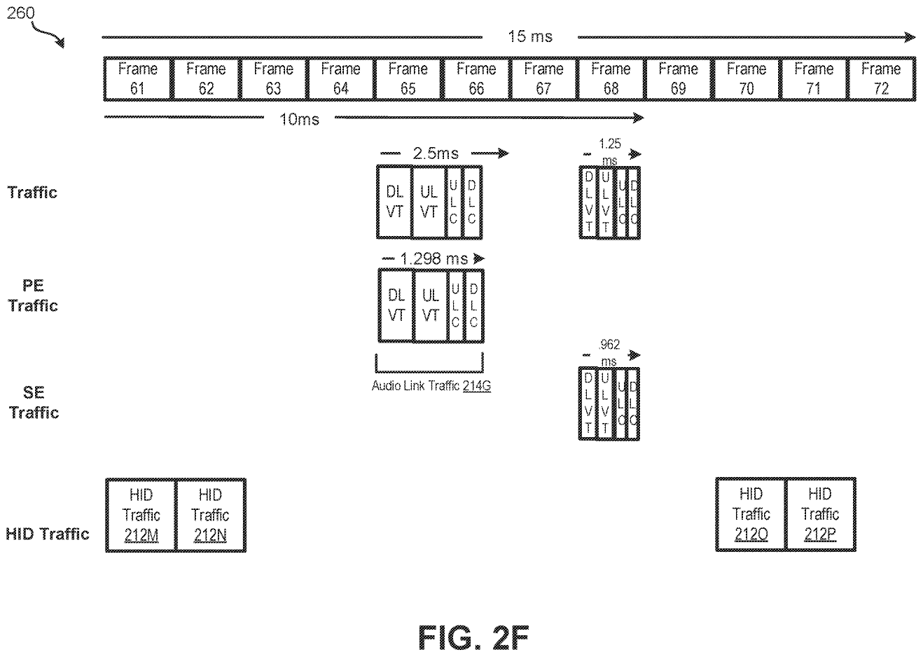

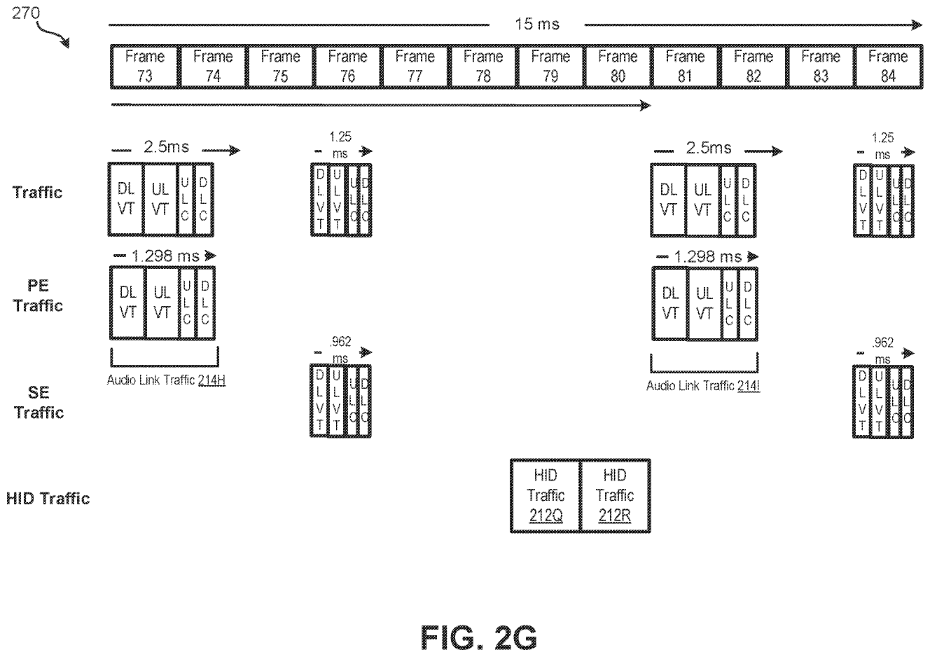

FIGS. 2A-2G illustrate transmitting audio link traffic and HID traffic across frames of different intervals. Using techniques described herein, in some examples, the computing device 130, which may be referred to herein as the call gateway (CG) is configured to prioritize HID traffic over one or more types of audio link traffic, such as CIE traffic (uplink and/or downlink).

For purposes of explanation with regard to FIGS. 2A-2G, assume that each earbud 120 has a control link connection and an audio link connection with the computing device 130. The following QoS specifications are used within the example of FIGS. 2A-2G: QoS Configuration Setting: 32_2_1; Codec_ID: LC3; Supported Sampling Frequencies (KHz): 32; SDU Interval (ms): 10; Supported Octets per Codec Frame (Octets): 80 (64 Kbps); Framing: Unframed;

Retransmission Number: 2; and Max_Transport_Latency (ms): 10. The DL is transmitted to both earbuds 120 individually by the CG and the UL is received from one of the earbuds 120, such as from CT (Bud_A).

As illustrated in FIGS. 2A-2G, the HID traffic uses an 11.25 ms interval and the audio link traffic uses a 10 ms interval to meet the specified QoS. The audio link traffic includes both the audio traffic (e.g., uplink/downlink) as well as the CIE traffic used to communicate the uplink/downlink CIEs. Based on the above parameters, the HID and audio link intervals, FIGS. 2A-2G show one full cycle of HID and audio traffic placements that start at Frame 7 and end at Frame 78. The second cycle would have the same placement as the first cycle and start at Frame 79. The cycle of 90 ms is determined using the least common multiple of the HID and audio link intervals of 11.25 ms and 10 ms respectively.

Referring to FIG. 2A, it can be seen in interval 210, that includes frames 1-12, that there is no conflict between the HID traffic 212A-212B that begins at frame 7 and ends at frame 8 and the audio link traffic 214A that begins at frame 9 and ends in frame 10. As such, there is no delay in the HID traffic being delivered. As briefly discussed above, however, prior to techniques described herein, the call gateway, such as computing device 130, would prioritize any audio link traffic over the HID traffic regardless of the type of audio link traffic.

Turning to FIG. 2B, it can be seen in interval 220 (frames 13-24) that a conflict exists between the HID traffic 212C-212D starting at frame 17 with the audio link traffic 214B that is also scheduled to start at frame 17. Generally, when a conflict exists between HID traffic, such as HID traffic 212C-212D, and audio link traffic, such as audio link traffic 214B, the audio link traffic 214 is transmitted, but the HID traffic 212 is not transmitted as shown by the cross sign (X) within FIG. 2B.

The conflict illustrated in FIG. 2B includes a conflict between the transmission of the uplink audio link traffic and the downlink audio link traffic but does not include a conflict between the uplink close CIE or the downlink close CIE illustrated. The uplink close CIE or the downlink close CIE may be referred to herein as CIE traffic 216, such as CIE traffic 216A. The audio link traffic 214 that includes the DL VT and the UP VT may be referred to herein as audio traffic 218 or voice traffic 218. According to some examples, the audio link traffic 214 is prioritized by the CG over the HID traffic 212 in the cases when there is a conflict that involves the uplink and downlink audio link traffic. In other examples, the HID traffic 212 is prioritized by the CG when there is a conflict between the HID traffic 212 and the CIE traffic 216 (e.g., the portion of the audio link traffic that includes one or more of the uplink close CIE or the downlink close CIE).

As such, in the example of the conflict illustrated in FIG. 2B, the HID traffic 212C-212D would not be transmitted at frames 16-17. According to some examples, in cases when the CG has other latency sensitive (e.g., HID traffic) or throughput intensive (e.g., Wi-Fi in 2.4 GHz band) activities ongoing in parallel then the CG prioritizes those activities over the CIE traffic 216 for an improved user experience. This helps to ensure that audio quality remains good as the audio traffic has been delivered and the user experience of other ongoing activities (e.g., improved CG's HID latency and Wi-Fi throughput).

As FIGS. 2A-2G illustrate, the HID traffic 212 has overall eight different possibilities for transmission in a 90 ms cycle. Five of the conflicts are with the audio traffic and in these cases, the audio traffic is prioritized over the HID. In the case where the CIE traffic conflicts with the HID traffic, the CG prioritizes the HID traffic. For example, the HID traffic in frames 34-35 is prioritized over CIE traffic scheduled for frames 34-35.

The interval 230 including frames 25-36, illustrated in FIG. 2C, shows a conflict between the DL VT and UL VT traffic of the audio link traffic 214C and HID traffic 212E-212F.

According to techniques described herein, the audio link traffic 214C would be prioritized over the HID traffic 212E-212F. The interval 230 also shows a conflict in frame 34 between the CIE traffic 216B and HID traffic 212G-212H. According to techniques described herein, the HID traffic 212G-212H is prioritized over the transmission of the CIE traffic 216B. The interval 240 including frames 37-48, illustrated in FIG. 2D, shows a conflict between the DL VT and UL VT traffic of the audio link traffic 214E and HID traffic 2121-212J. According to techniques described herein, the audio link traffic 214E would be prioritized over the HID traffic 212E-212F. The interval 250 including frames 49-60, illustrated in FIG. 2E, shows a conflict between the DL VT and UL VT traffic of the audio link traffic 214F and HID traffic 212K-212L. According to techniques described herein, the audio link traffic 214F would be prioritized over the HID traffic 212E-212F. The interval 260 including frames 61-72, illustrated in FIG. 2F, shows no conflicts between the audio link traffic 214G and HID traffic 212M-212P. The interval 270 including frames 73-84, illustrated in FIG. 2G, shows no conflicts between the audio link traffic 214H-214I and HID traffic 212Q-212R.

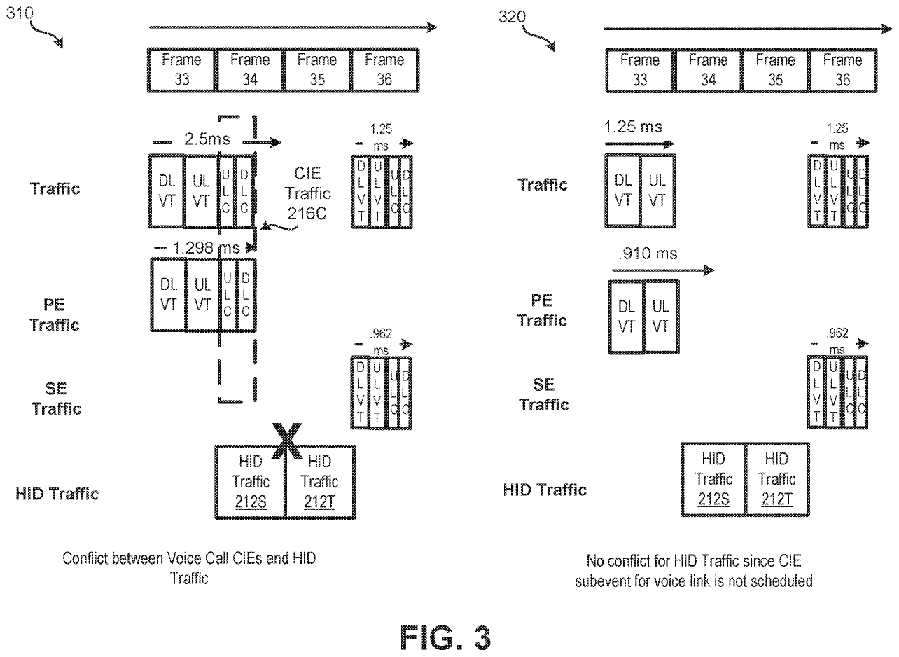

Turning to FIG. 3, a conflict is shown between the HID traffic 212 and the CIE traffic 216. Indicator 310 shows that, using prior techniques, the CIE traffic 216C that includes an uplink CIE and a downlink CIE is scheduled by the CG to begin at frame 34. The CIE traffic 216A would conflict with the HID traffic 212S and 212T in this example, and using the prior techniques the HID traffic would not be transmitted. By prioritizing the HID traffic over the CIE traffic as illustrated by indicator 320, the HID traffic 212S and 212T is transmitted, and the CIE traffic 216C is not transmitted since it is not scheduled.

Referring to FIGS. 2A-2G it can be seen that there are five consecutive HID traffic conflicts illustrated and, therefore, HID traffic would not be delivered for 56.25 ms (5*11.25) using prior techniques that do not prioritize HID traffic over any type of audio link traffic. A delay of this length can negatively affect the user experience since HID responsiveness issues. This delay can be perceived by user when the user notices the lag in their interactions with the HID device and the corresponding display of the activity on a display (e.g. the lag between user moving the mouse and cursor moving on the display).

To reduce this lag in performance that can result in a poor user experience, the CG, such as the computing device 130, is configured to not schedule a CIE for the audio link with an earbud such that there is not a conflict between the HID traffic and the audio traffic. In the current example of FIGS. 2A-2G, when the CG does not schedule the CIE for the audio link with the PE, the HID traffic is communicated four times (instead of three) out of the possible eight times in each 90 ms duration. This is 12.5% improvement in usable bandwidth availability for HID traffic. Prioritizing the HID traffic over CIE traffic also reduces the number of consecutive HID occurrences where HID traffic does not go through to two occurrences instead of five. As such, in the example of FIGS. 2A-2G, the longest continuous HID duration for which HID traffic is not delivered is 22.5 ms (11.25*2) instead of 56.25 ms using prior techniques. This reduces the HID latency to 22.5 ms from 56.25 ms. Accordingly, the techniques described herein improves the HID performance greatly, helps the HID responsiveness issue, and provides a better overall user experience.

While the example illustrated in FIGS. 2A-2G show that both the PE and the SE have a control and an audio link with the CG, other topologies can be used. For example, in other configurations, the PE may have a control link and an audio link with the CG, while the SE does not have a separate control link and audio link. Instead, the SE may passively sniff the links between the CG and the PE. In some instances, the performance of the CG is also improved if the CG had any other activity to perform along with a voice call. The example of other activities include but are not limited to Wi-Fi in 2.4 GHz band, BLE scans, and the like.

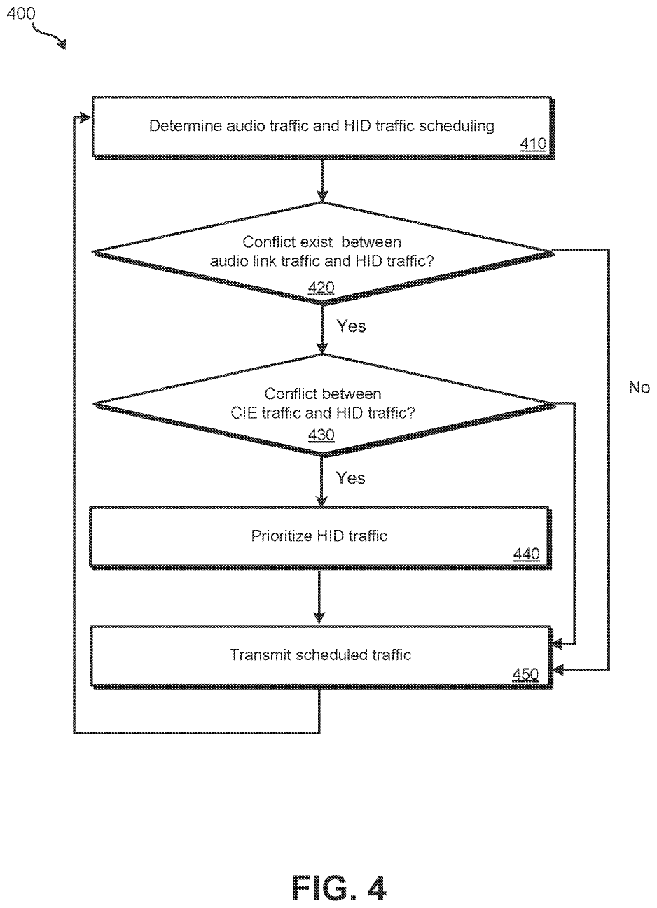

Various methods may be performed using the systems, states, and arrangements detailed in relation to FIGS. 1-3. FIG. 4 illustrates an embodiment of a method 400 that prioritizes HID traffic over a CIE traffic.

At block 410, the scheduling of the audio link traffic 214 and the HID traffic 212 is determined. As discussed above, a CG, such as computing device 130 may include one or more audio link connections and one or more HID traffic connections. For instance, the CG may have an audio link with a PE, and an HID link with a device, such as a keyboard, mouse, or some other device. The CG may determine what data is to be transmitted/received over the audio link and what data is to be transmitted/received over the HID link within an interval, or some number of frames.

At block 420, a decision is made as to whether a conflict exists between audio link traffic 214 and HID traffic 212. As discussed above, the CG may determine that at least a portion of the audio link traffic 214 conflicts with at least a portion of the HID traffic 212. For example, the conflict may be that the DL and UL audio traffic conflicts with the HID traffic 212, or the conflict may be that the scheduling of the CIE traffic 216 conflicts with the HID traffic 212. When there is a conflict, the method moves to block 430. When there is not a conflict, the process moves to 450.

At block 430, a decision is made as to whether a conflict exists between a CIE traffic 216 and the HID traffic 212. As discussed above, the CG may determine that the DL and UL traffic for a particular event has been completed but that a CIE traffic 216 has not been transmitted. In some cases, the CIE traffic 216 may occur at the start of a frame that would interfere with HID traffic 212. When there is a conflict, the method moves to block 440. When there is not a conflict, the process moves to 450.

At block 440, the HID traffic 212 is prioritized. As discussed above, the CG may prioritize the HID traffic 212 over the CIE traffic 216 by preventing the transmission of the CIE traffic 216. In some cases, the CG does not schedule the CIE traffic 216 when there is a conflict with the HID traffic 212 such that the HID traffic 212 can be received.

At block 450, the scheduled traffic is transmitted. As discussed above, the CG may prioritize and schedule the HID traffic 212 in some cases and prioritize the audio link traffic on other examples.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for managing usage of Bluetooth Low Energy (BLE) bandwidth, the method comprising:
establishing a Connected Isochronous Stream (CIS) connection to communicate audio link traffic between a first computing device and a second computing device;
determining a conflict between the audio link traffic and Human Interface Device (HID) traffic; and
prioritizing the HID traffic over the audio link traffic based at least in part on the conflict.

2. The method of claim 1, wherein determining the conflict comprises determining that Close Isochronous Event (CIE) traffic conflicts with the HID traffic.

3. The method of claim 2, wherein prioritizing the HID traffic over the audio link traffic comprises preventing the CIE traffic from one or more of being scheduled or transmitted.

4. The method of claim 1, further comprising determining that the CIS connection is used for a super wide band call that has an audio bandwidth greater than about 14 KHz.

5. The method of claim 1, further comprising transmitting CIE traffic when no conflict exists.

6. The method of claim 1, wherein the HID traffic includes data associated with an input device.

7. The method of claim 1, wherein the second computing device is an earbud.

8. A wireless system that uses a Bluetooth Low Energy (BLE) protocol, comprising:
a first computing device, comprising a first wireless interface, and a first processing system, wherein the first computing device is configured to:
establish a Connected Isochronous Stream (CIS) connection to communicate audio link traffic between the first computing device and a second computing device;
determine a conflict between the audio link traffic and Human Interface Device (HID) traffic; and
prioritize the HID traffic over the audio link traffic based at least in part on the conflict.

9. The wireless system of claim 8, wherein determining the conflict comprises determining that Close Isochronous Event (CIE) traffic conflicts with the HID traffic.

10. The wireless system of claim 9, wherein prioritizing the HID traffic over the audio link traffic comprises preventing the CIE traffic from one or more of being scheduled or transmitted.

11. The wireless system of claim 8, wherein the CIS connection is used for a super wide band call that has an audio bandwidth greater than about 14 KHz.

12. The wireless system of claim 8, wherein the first computing device is further configured to transmit CIE traffic when no conflict exists.

13. The wireless system of claim 8, wherein the HID traffic includes data associated with an input device.

14. The wireless system of claim 8, wherein the second computing device is an earbud.

15. A non-transitory computer-readable medium containing computer executable instructions that, when executed by a processor, cause the processor to perform a method, comprising:
establishing a Connected Isochronous Stream (CIS) connection to communicate audio link traffic between a first computing device and a second computing device;
determining a conflict between the audio link traffic and Human Interface Device (HID) traffic; and
prioritizing the HID traffic over the audio link traffic based at least in part on the conflict.

16. The non-transitory computer-readable medium of claim 15, wherein determining the conflict comprises determining that Close Isochronous Event (CIE) traffic conflicts with the HID traffic.

17. The non-transitory computer-readable medium of claim 16, wherein prioritizing the HID traffic over the audio link traffic comprises preventing the CIE traffic from one or more of scheduled or transmitted.

18. The non-transitory computer-readable medium of claim 15, wherein the CIS connection is used for a super wide band call that has an audio bandwidth greater than about 14 KHz.

19. The non-transitory computer-readable medium of claim 15, wherein the computer executable instructions that, when executed by a processor, further cause the processor to transmit CIE traffic when no conflict exists.

20. The non-transitory computer-readable medium of claim 15, wherein the HID traffic includes data associated with an input device and the second computing device is an earbud.
